(19) United States
(12) Patent Application Publication
(10) Pub. No.: US 2014/0164911 A1
(43) Pub. Date: Jun. 12, 2014

(54) PRESERVING LAYOUT OF REGION OF CONTENT DURING MODIFICATION

(71) Applicant: MICROSOFT CORPORATION, Redmond, WA (US)

(72) Inventors: Radoslav Nickolov, Seattle, WA (US); Ming Liu, Bellevue, WA (US); Wei Zeng, Sammamish, WA (US); Raman Narayanan, Seattle, WA (US)

(73) Assignee: Microsoft Corporation, Redmond, WA (US)

(21) Appl. No.: 13/711,130

(22) Filed: Dec. 11, 2012

(51) Int. Cl. G06F 17/21

(52) U.S. Cl. CPC G06F 17/212
USPC 715/243

(57) ABSTRACT

An e-reader application preserves a layout of a region of content during a modification. A detected modification of a region of the content initiates an analysis for how to preserve the region. A configuration located within the content determines a behavior for preserving the region. The configuration is evaluated and compared to other configurations to determine overriding attributes to apply to the region during the modification. The attributes are applied to the associated objects in the region while applying the modification to other objects to maintain a pre-modification appearance of the region after the modification.

### BACKGROUND

Mobile computing has transformed media consumption across markets. Miniaturization across product generations has enabled more functionality to be accomplished by smaller devices. A modern smartphone has more computing capacity than a desktop computer a few years ago. Mature product processes have also enabled advances in technology to be integrated to automated production of mobile devices seamlessly. Extensive automation has led to inexpensive components. Inexpensive components have enabled manufacturing of inexpensive mobile devices providing functionality on the go.

Content presentation in mobile devices has significant room for improvement. Certain content such as e-books are strictly structured. Structured content is rarely optimized for user interaction. Resize operations are usually restricted or not allowed. Magnification of objects within such structured content can also be further restricted to comply with disability restrictions.

Alternatively, applications and devices providing free access to content display attributes can have trouble controlling the display characteristics of the content. A simple resize operation can misadjust the content to display parameters beyond an author's intent. In an example, a magnification operation can blow the content out of proportion and force to user to endless scrolling for interaction with regions of the content. Excessive scrolling can disrupt content flow and can take away from the user experience. In addition, the author's intent on viewing content based on a workflow can be destroyed by extensive adjustments of the content display parameters.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to preserving a layout of a region of content during a modification. According to embodiments, an application of an e-reader device may detect a modification of a region of content. A modification may include a resize event including a magnification or a reduction of a region. The region may include a variety of media including but not exclusive to text, graphic, audio, video, combinations, etc. In response to the modification, the content may be evaluated to determine a configuration for preserving a layout of the region. Furthermore, a region, as used herein, is not restricted to a physical region with geometric boundaries. A region may include any portion of content such as the paragraphs of HTML text in a web page. In particular, properties that may be modified may include font size, font face, and the like, which determine layout regions but also determine other aspects of visual appearance such as line spacing. The configuration may be one tier of a list of configurations of the content. The list may be prioritized. The configuration may be given a high priority to override other configurations in the list. Next, the region may be preserved based on the configuration while applying the modification. A magnification factor may be applied to objects in the region based on the configuration to maintain proportion of the objects during application of a resize operation to the region.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates an example architectural diagram of preserving a layout of a region of content during a modification in an e-reader according to some embodiments;

FIG. 2 illustrates an example of content regions preserved during a modification according to embodiments;

FIG. 3 illustrates an example of preserving a content region based on a configuration during a modification in an e-reader according to embodiments;

FIG. 4 is a networked environment, where a system according to embodiments may be implemented;

FIG. 5 is a block diagram of an example computing operating environment, where embodiments may be implemented; and

FIG. 6 illustrates a logic flow diagram for a process preserving a region of content during a modification in an e-reader according to embodiments.

### DETAILED DESCRIPTION

As briefly described above, a layout of a region of content may be preserved during a modification. An application of an e-reader device may determine a configuration within the content for preserving the region in response to detecting the modification. The layout of the region may be preserved based on the configuration while applying the modification.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present disclosure is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for preserving a layout of a region of content during modification. Examples of platforms include, but are not limited to, a hosted service executed over a plurality of servers, an application executed on a single computing device, and comparable systems. The term “server” generally refers to a computing device executing one or more software programs typically in a networked environment. More detail on these technologies and example operations is provided below.

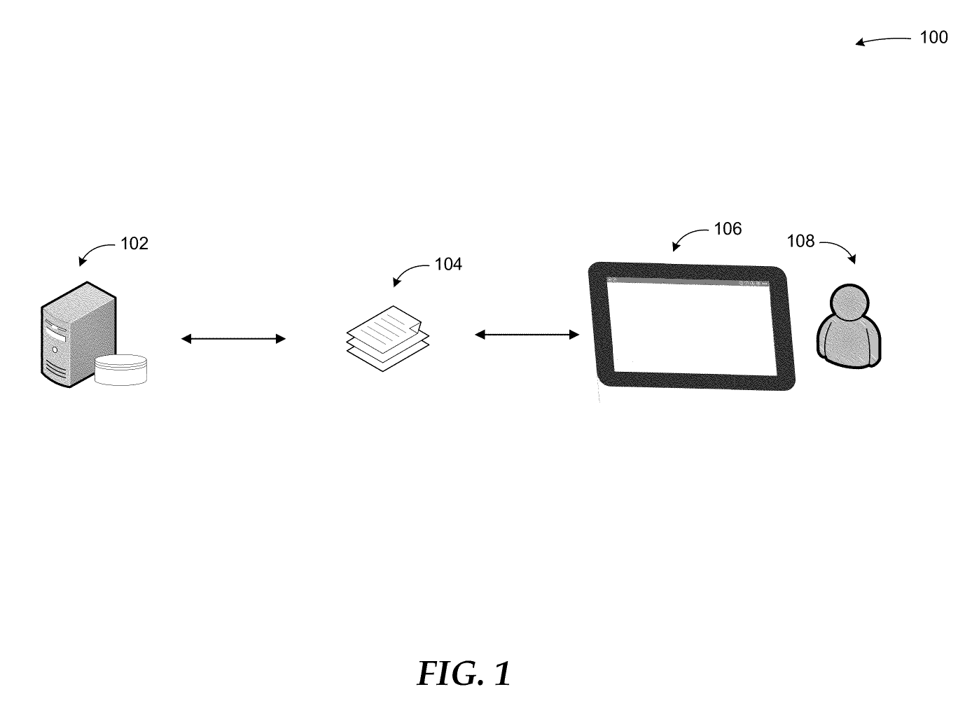

FIG. 1 illustrates an example architectural diagram of a region of content during a modification in an e-reader according to embodiments. The components and environments shown in diagram 100 are for illustration purposes. Embodiments may be implemented in various local, networked, cloud-based and similar computing environments employing a variety of computing devices and systems, hardware and software.

An “e-reader” device such as a tablet 106 may host an application providing content 104 to a user 108. Such an application may be called an e-reader application, which may be a locally installed and executed application receiving content (e.g., e-books, documents, etc.) through wired or wireless networks. The e-reader application may also be a hosted service provided by one or more servers and accessed by a user through the e-reader device (e.g., tablet 106). Content may be any type of consumable data including but not exclusive to text, audio, video, graphic, etc. Content may also include media combinations presented in a standardized format (i.e.: a web page.) Content may be provided by a content server 102 hosting the content for consumption by services and devices.

An application according to embodiments may be a standalone application executed in a tablet device 106. A standalone application may detect a modification of the content 104 displayed on tablet 106. The modification may be an action by user 108 to adjust a size of the displayed content. The application may evaluate the content 104 for a configuration to enforce preservation of a region of the content while applying the modification. The region may be preserved based on the configuration by implementing specified attribute settings for the region.

Embodiments are not limited to implementation in a tablet 106. An application according to embodiments may preserve a layout of a region of content during a modification in other platforms. A user may apply a modification to the region of the content in any device capable of displaying the content. A touch or gesture enabled device is not necessary. A user may modify the content using a standard mouse and keyboard interface or other forms of input such as a gyroscopic input device, eye-tracking, and similar input mechanisms.

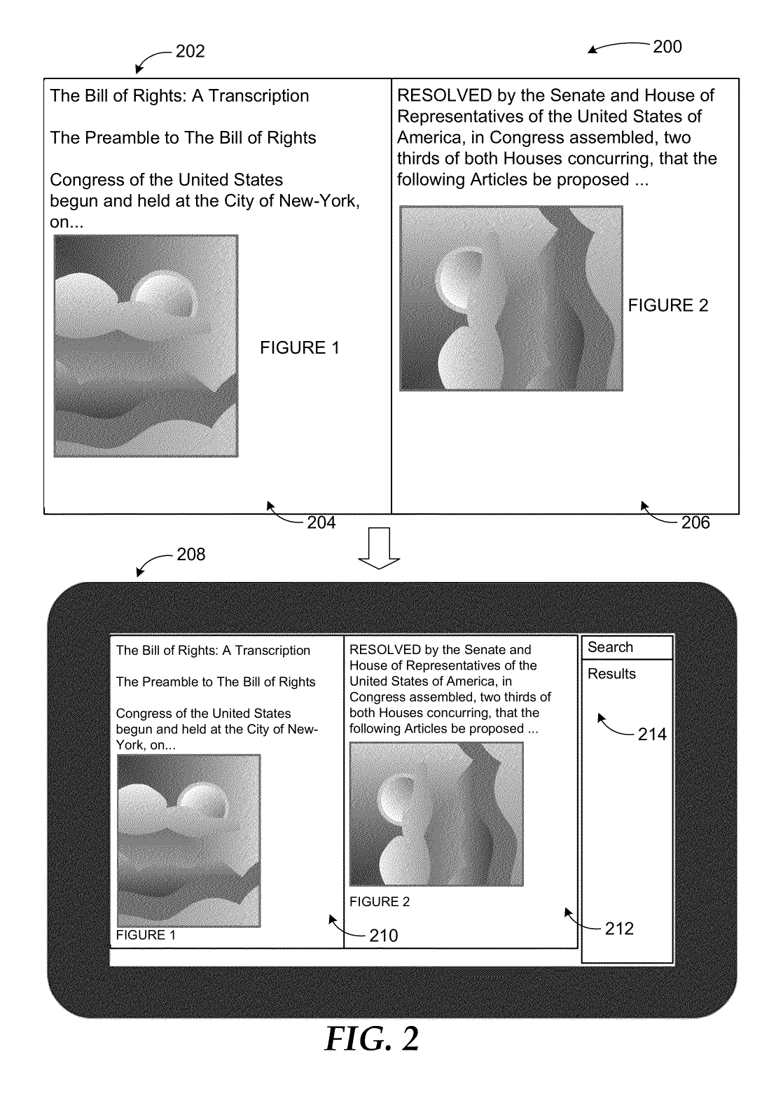

FIG. 2 illustrates an example of content regions preserved during a modification according to embodiments. Diagram 200 displays an application of an e-reader device preserving a columned layout of a displayed content.

A portion of the content 202 may be partitioned to columns (regions 204 and 206). Each column may have attributes specifying how to arrange objects for display. Objects may include text and figures, for example. An attribute for text may include font style and size. A text attribute may also specify how to arrange the text including line break position, line size, etc. Highlighting and shading may also be specified by the text attribute. The text attribute may also specify a ratio setting to maintain a ratio of the text size in proportion to the region such as a column or a page of the content.

An attribute (within the configuration) for a graphic object such as an image may specify size, location, and shape settings for the graphic. The size, location, and shape settings may be predetermined values. Alternatively, the size, location, and shape settings may be variable and set according to a ratio in proportion to the region such as column or page of the content. In an example scenario, a width of the graphic may be set to be a proportion of the width of the region.

The tablet 208 may display the content 202 after a modification. The modification may be an activation of a search box 214 which may resize displayed columns 210 and 212 of the content. The search box may use screen area otherwise dedicated to displayed content. The content 202 may need to be resized based on a configuration associated with the content to preserve the regions 204 and 206. In an example scenario, the application may determine width attributes of the regions 204 and 206 from a configuration of the content 202. The width attributes may be readjusted to available width (or length) in the display area of tablet 208. The objects displayed in columns 210 and 212 may be resized to fit the available width (or length) in the tablet 208. In addition, the application may decrease (or increase) a font size attribute of the text in columns 210 and 212 to match a character number per line attribute of the regions 204 and 206. Image size may be adjusted to fit the images to available space in columns 210 and 212 to match the look of the regions 204 and 206 based on available width and length attributes in the screen space of tablet 208.

As discussed above, a region, as used herein, is not restricted to a physical region with geometric boundaries. A region may include any portion of content such as the paragraphs of HTML text in a web page. In particular, properties that may be modified may include font size, font face, and the like, which determine layout regions but also determine other aspects of visual appearance such as line spacing. A layout, as used herein, may also cover any properties related to the presentation of content such as font face or color scheme. In particular, preserving the properties during modification may include preserving any aspect of the original authoring intent that the application deems important. For example, in the case of text size, the relative sizes of various text components such as size of main body text vs. headings may be preserved. In another example, a color theme may be modified, and in doing so the relative contrasts specified by the original authoring may be preserved. An example of preserving numerical values is magnification (or reduction), but preservation of numerical values is not restricted to those illustrative examples. For example, if the original size proportions for body text vs. headings were 12/16, a magnified modification may be 18/30 rather than applying a uniform factor leading to 18/24.

According to some embodiments, a configuration within the content may specify attributes associated with a region of the content. The region may include a column, a table, a page, etc. Attributes may be retrieved from the configuration to maintain the appearance of the region. The attributes may include size of the region and position of objects within the content. The attributes may be applied according to available resources within the redrawn region. Available resources may include width and length of the available space. In an example scenario, a table may be resized to fit an available region. Each cell within the table may be resized to fit the region. Each object within the cell may be resized to fit the redrawn cell.

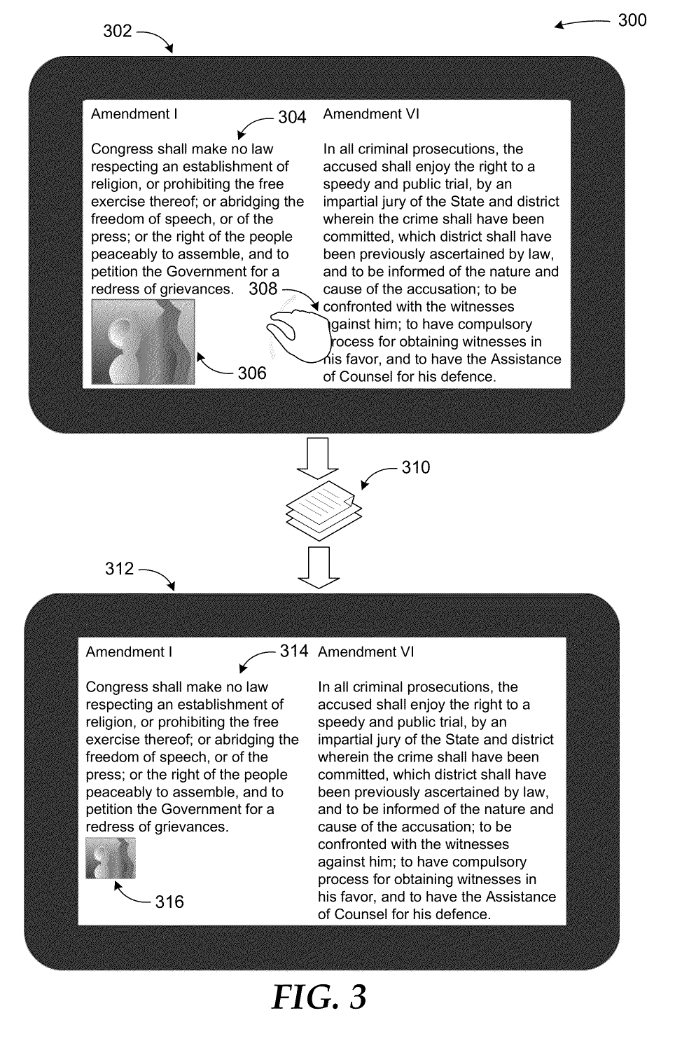

FIG. 3 illustrates an example of preserving a content region based on a configuration during a modification according to embodiments. Diagram 300 displays preservation of a region of the content while applying a resize operation 308.

An e-reader application executed in device 302 may respond to a user action to resize region 304. The region 304 may include objects including text and a graphic 306. The objects may be displayed in a structure such as a column, table, or a page. The displayed content may be partitioned to multiple structures including multiple columns, tables, or pages.

In response to detecting a modification such as the resize operation 308 to reduce the displayed content, the application may evaluate the content 310 for a configuration. The configuration may be located within a tier of a list based structure. The list may be a settings file encompassing multiple configurations. The list may be ordered. A configuration in a lower tier of the list may override a configuration in a higher tier. In an example scenario, a magnification factor in a configuration may specify a relative size of an object (such as text) in relation to a size of the screen. The application may apply the magnification factor in response to detecting a modification of the object within the region 304.

Alternatively, the configuration may be inserted as a tier at the bottom of the list. The list may encompass the content in partitions. Each partition may be stored as a tier in the list. When the application resizes the region 304, the tier containing the region 304 may be reloaded into the tablet device 312. A magnification factor may be applied to the region 314 to preserve a relative size attribute in relation to the screen space of tablet device 312. The magnification factor may only apply to specified objects in the region including text. Other objects such as image 316 may be resized according to the modification if not specified for preservation by the configuration and outside an influence of the configuration.

The example scenarios and schemas in FIG. 2 through 3 are shown with specific objects, data types, and configurations. Embodiments are not limited to systems according to these example configurations. Preserving a layout of a region of content during a modification in an e-reader may be implemented in configurations employing fewer or additional components in applications and user interfaces. Furthermore, the example schema and components shown in FIG. 2 through 3 and their subcomponents may be implemented in a similar manner with other values using the principles described herein.

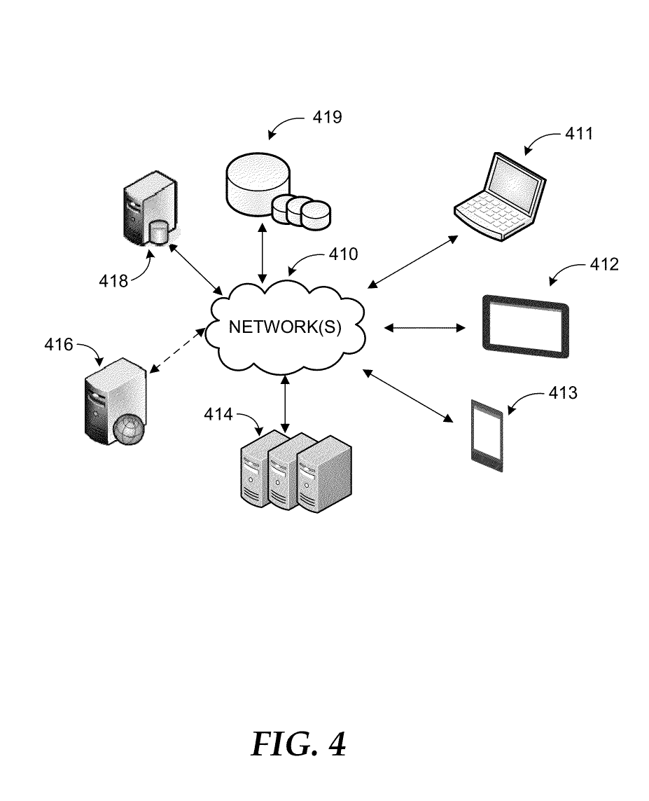

FIG. 4 is a networked environment, where a system according to embodiments may be implemented. Local and remote resources may be provided by one or more servers 414 or a single server (e.g. web server) 416 such as a hosted service. An application may execute on individual computing devices such as a smart phone 413, a tablet device 412, or a laptop computer 411 (‘client devices’) and communicate with a content resource through network(s) 410.

As discussed above, an e-reader application may preserve a layout of a region of content in response to a modification. The application may preserve a layout of the region based on a configuration while applying the modification. The preserved region may be displayed in an e-reader device. Client devices 411-413 may enable access to applications executed on remote server(s) (e.g. one of servers 414) as discussed previously. The server(s) may retrieve or store relevant data from/to data store(s) 419 directly or through database server 418.

Network(s) 410 may comprise any topology of servers, clients, Internet service providers, and communication media. A system according to embodiments may have a static or dynamic topology. Network(s) 410 may include secure networks such as an enterprise network, an unsecure network such as a wireless open network, or the Internet. Network(s) 410 may also coordinate communication over other networks such as Public Switched Telephone Network (PSTN) or cellular networks. Furthermore, network(s) 410 may include short range wireless networks such as Bluetooth or similar ones. Network(s) 410 provide communication between the nodes described herein. By way of example, and not limitation, network(s) 410 may include wireless media such as acoustic, RF, infrared and other wireless media.

Many other configurations of computing devices, applications, data sources, and data distribution systems may be employed to preserve a region of content during a modification in an e-reader. Furthermore, the networked environments discussed in FIG. 4 are for illustration purposes only. Embodiments are not limited to the example applications, modules, or processes.

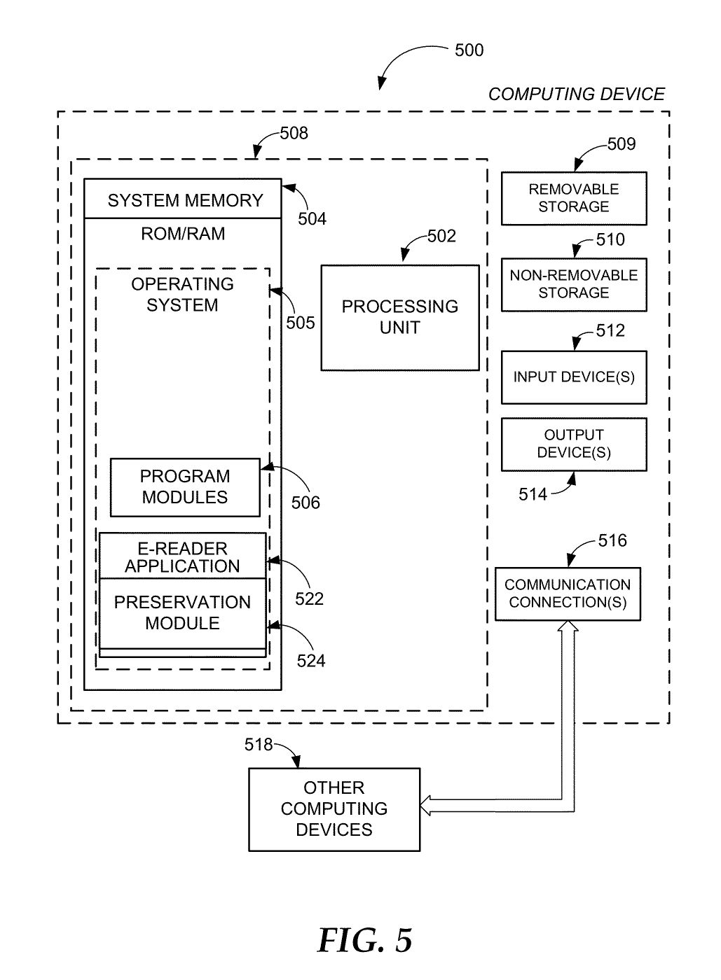

FIG. 5 and the associated discussion are intended to provide a brief, general description of a suitable computing environment in which embodiments may be implemented. With reference to FIG. 5, a block diagram of an example computing operating environment for an application according to embodiments is illustrated, such as computing device 500. In a basic configuration, computing device 500 may include at least one processing unit 502 and system memory 504. Computing device 500 may also include a plurality of processing units that cooperate in executing programs. Depending on the exact configuration and type of computing device, the system memory 504 may be volatile (such as RAM), non-volatile (such as ROM, flash memory, etc.) or some combination of the two. System memory 504 typically includes an operating system 505 suitable for controlling the operation of the platform, such as the WINDOWS® and WINDOWS PHONE® operating systems from MICROSOFT CORPORATION of Redmond, Wash. The system memory 504 may also include one or more software applications such as program modules 506, an e-reader application 522, and a preservation module 524.

An e-reader application 522 may detect a modification of a region of content. The region may contain multiple media objects such as text and graphics. The application 522 may determine a configuration within the content for preserving the region in response to the modification. The preservation module 524 may process the content to locate a tier encompassing the configuration. The tier may be stored in a list. The list may be a structure encompassing the content and the configuration or the configuration only. A magnification factor (an attribute stored in the configuration) for objects in the region may be enforced while applying the modification. This basic configuration is illustrated in FIG. 5 by those components within dashed line 508.

Computing device 500 may have additional features or functionality. For example, the computing device 500 may also include additional data storage devices (removable and/or non-removable) such as, for example, magnetic disks, optical disks, or tape. Such additional storage is illustrated in FIG. 5 by removable storage 509 and non-removable storage 510. Computer readable storage media may include volatile and nonvolatile, removable and non-removable media implemented in any method or technology for storage of information, such as computer readable instructions, data structures, program modules, or other data. Computer readable storage media is a computer readable memory device. System memory 504, removable storage 509 and non-removable storage 510 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer readable storage media may be part of computing device 500. Computing device 500 may also have input device(s) 512 such as keyboard, mouse, pen, voice input device, touch input device, and comparable input devices. Output device(s) 514 such as a display, speakers, printer, and other types of output devices may also be included. These devices are well known in the art and need not be discussed at length here.

Computing device 500 may also contain communication connections 516 that allow the device to communicate with other devices 518, such as over a wireless network in a distributed computing environment, a satellite link, a cellular link, and comparable mechanisms. Other devices 518 may include computer device(s) that execute communication applications, storage servers, and comparable devices. Communication connection(s) 516 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be co-located with each other, but each can be only with a machine that performs a portion of the program.

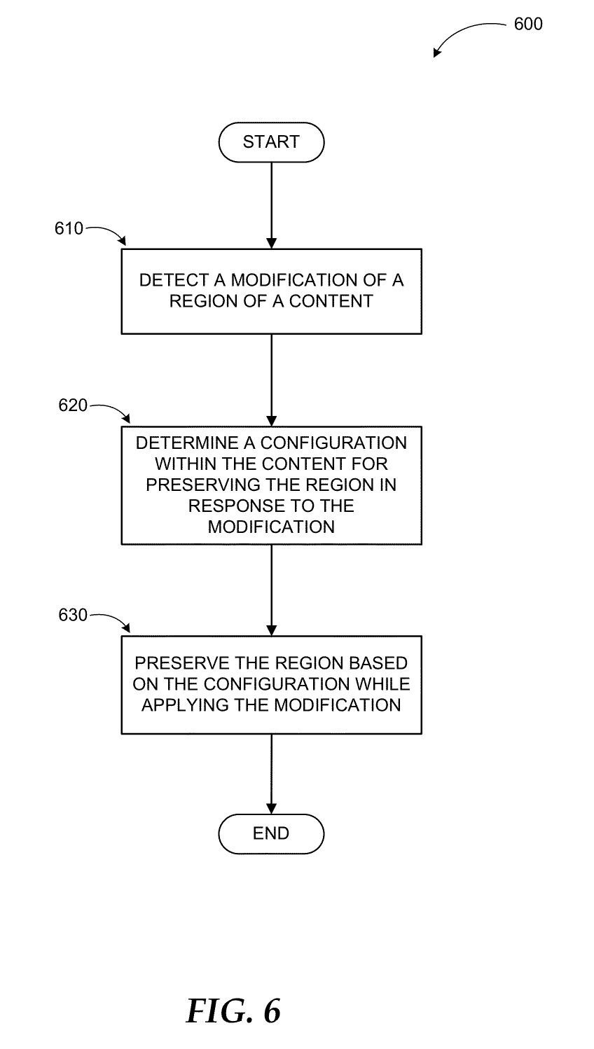

FIG. 6 illustrates a logic flow diagram for a process preserving a layout of a region of content during a modification in an e-reader according to embodiments. Process 600 may be implemented by an e-reader application in some examples.

Process 600 may begin with operation 610 where the e-reader application may detect a modification of a region of content. The modification may include a resize operation initiated by a user. The region may be a section of the displayed content such as a column, a page, a table, etc. The application may determine a configuration within the content for preserving the region in response to the modification at operation 620. The configuration may be a tier within a list. The list may encompass multiple configurations which may be ordered to enforce an attribute of the region in response to the detected modification. At operation 630, the region may be preserved based on the configuration while applying the modification. A magnification factor may be applied to an object of the region as specified by the configuration.

Some embodiments may be implemented in a computing device that includes a communication module, a memory, and a processor, where the processor executes a method as described above or comparable ones in conjunction with instructions stored in the memory. Other embodiments may be implemented as a computer readable storage medium with instructions stored thereon for executing a method as described above or similar ones.

The operations included in process 600 are for illustration purposes. Preserving a layout of a region of content during a modification, according to embodiments, may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed on a computing device for preserving a layout of a region of content during a modification, the method comprising:
detecting a modification action associated with the region of the content;
determining a configuration within the content for preserving the layout of the region in response to the modification action; and
preserving the layout of the region based on the configuration while applying the modification.

2. The method of claim 1, further comprising:
retrieving the configuration from a list including tiers; and
locating the configuration at a bottom tier.

3. The method of claim 2, further comprising:
locating the bottom tier after other tiers encompassing partitions of the content.

4. The method of claim 2, further comprising:
locating the bottom tier after other tiers encompassing other configurations.

5. The method of claim 2, further comprising:
evaluating the configuration at the bottom tier to override another configuration in a higher tier.

6. The method of claim 1, further comprising:
determining an attribute including a magnification factor in the configuration to apply to the region.

7. The method of claim 6, further comprising:
evaluating a size attribute of at least one object in the region; and
applying the magnification factor to the size attribute.

8. The method of claim 1, further comprising:
determining a text based object within the region to apply the configuration.

9. The method of claim 8, further comprising:
applying at least one of: a font size attribute and a font style attribute in the configuration to the text based object.

10. The method of claim 1, further comprising:
resizing other objects encompassed within the region and outside of an influence of the configuration, based on the modification.

11. A computing device for preserving a layout of a region of content during a modification in an e-reader, the computing device comprising:
a memory configured to store instructions; and
a processor coupled to the memory, the processor executing an application in conjunction with the instructions stored in the memory, wherein the application is configured to:
detect a modification action associated with the region of the content;
determine a configuration within the content for preserving the layout of the region in response to the modification action; and
preserve the layout of the region based on the configuration while applying the modification based on a process to:
apply the configuration to an object within the region associated with the configuration; and
apply the modification to another object within the region not associated with the configuration.

12. The computing device of claim 11, wherein the modification action includes a resize operation applied on the region

13. The computing device of claim 11, wherein the application is further configured to:
determine the region to include at least one of: a column, a table, and a page; and
apply the modification based on the included one of the column, the table, and the page.

14. The computing device of claim 11, wherein the application is further configured to:
evaluate a screen width and a screen length;
determine a region width attribute and a region length attribute from the configuration.

15. The computing device of claim 14, wherein the application is further configured to:
resize the region based on at least one of: reducing and magnifying the region to match the region width attribute to the screen width.

16. The computing device of claim 14, wherein the application is further configured to:
resize the region based on at least one of: reducing and magnifying the region to match the region length attribute to the screen length.

17. A computer-readable memory device with instructions stored thereon for preserving a layout of a region of content during a modification, the instructions comprising:
detecting a modification action associated with the region of the content;
determining a configuration within the content for preserving the layout of the region in response to the modification; and
preserving the layout of the region based on the configuration while applying the modification by:
applying the configuration to a text based object within the region associated with the configuration; and
applying the modification to another object within the region not associated with the configuration.

18. The computer-readable memory device of claim 17, wherein the instructions further comprise:
applying at least one of: a line size attribute and a line break position attribute in the configuration to the text based object.

19. The computer-readable memory device of claim 18, wherein the instructions further comprise:
applying at least one of: a highlighting and a shading attribute in the configuration to the text based object.

20. The computer-readable memory device of claim 18, wherein the instructions further comprise:
applying a ratio setting in the configuration to the text based object to maintain an appearance of the text based object in relation to the region and the other object within the region.
